(19) United States
(12) Patent Application Publication
(10) Pub. No.: US 2008/0148586 A1
(43) Pub. Date: Jun. 26, 2008

(54) Installation gauge for electrical fixtures

(76) Inventor: Joseph A. Morin, New Hampton, NH (US)

Correspondence Address: LITMAN LAW OFFICES, LTD., P.O. BOX 15035, CRYSTAL CITY STATION, ARLINGTON, VA, 22215, US

(21) Appl. No.: 11/642,677

(22) Filed: Dec. 21, 2006

(51) Int. Cl. G01B 1/00

(52) U.S. Cl. 33/528

(57) ABSTRACT

The installation gauge for electrical fixtures is a device for spacing or positioning a ceiling fixture at the proper height or depth relative to the interior or finish surface of the uninstalled wallboard or ceiling paneling during building construction. The gauge includes a pair of opposed gripping members, which secure temporarily to two spaced apart adjacent structural members, and an elongate flat plate extending there between. The plate is offset from the gripping members by an amount equal to the thickness of the uninstalled paneling in order to position an electrical fixture placed thereon at the proper height. The gripping members, in a first embodiment, are pairs of resilient plates configured to grip strapping members attached to the ceiling joists. The gripping members, in a second embodiment, are two opposed resilient members generally normal to the central plate, which resiliently grip the sides of two adjacent joists.

### BACKGROUND OF THE INVENTION

1. Field of the Invention

The present invention relates generally to gauges, guides, and jigs used in building construction. More specifically, the present invention relates to an installation gauge for electrical fixtures that provides a guide for placement and installation of an electrical box in the ceiling of a structure.

2. Description of the Related Art

The physical positioning of various electrical components (switch and outlet boxes, ceiling light fixtures, etc.) in a new structure, generally requires as much skill and expertise as the actual electrical work involved in the installation of such devices. For example, most structures are now finished using gypsum wallboard panels installed over the studs and joists comprising the wall and ceiling structure. The wallboard panels are generally on the order of 2 inch thick, and the exact positioning of electrical components relative to the as yet uninstalled wallboard must be considered in order to provide a pleasing finished installation where the lip of the fixture is flush with the finished surface of the wallboard.

This can be a challenging task, as the electrical box or fixture must be secured to some existing structure (e.g., a ceiling joist or permanently installed mounting bracket, etc.) before the wallboard is installed in new construction. Accordingly, the thickness of the uninstalled wallboard must be taken into account during the installation of the electrical boxes and fixtures, and measurement or placement errors at this point can result in uneven and/or unsightly installations. In fact, most electrical codes require that the front edges of electrical boxes and fixtures be no more than ¼ inch from the interior finished surface of the wallboard or other wall surface. Errors are even more likely when additional structure is installed between the joists and the yet to be installed wallboard (ceiling board). For example, it is common in some areas of the country to install strapping (a series of parallel stringers) across the ceiling joists to support additional insulation and/or provide an intermediate attachment surface for the wallboard between the joists.

There is a need for a device that will temporarily support an electrical box between ceiling joists until the box can be permanently attached to the joists or other supporting structure while properly positioning the box during installation. Thus, an installation gauge for electrical fixtures solving the aforementioned problems is desired.

### SUMMARY OF THE INVENTION

The installation gauge for electrical fixtures is a temporarily installed gauge that temporarily holds or supports an electrical fixture thereon, and positions the fixture at the proper depth relative to the finished or interior surface of the uninstalled wallboard paneling. The gauge grips the sides of two spaced apart adjacent structural members without fasteners or other attachment means.

A first embodiment of the gauge is configured for removable attachment to a pair of strapping members, which are permanently installed to the overlying ceiling joists. This embodiment of the gauge includes two mutually opposed strapping grip members, with each of the members having a pair of spaced apart fingers or plates dimensioned to grip the strapping member resiliently therebetween. The central portion of the device is an elongate flat plate, which is offset from the lower plates of the grip members by an amount equal to the thickness of the ceiling paneling to be installed. When an electrical fixture is temporarily placed atop the central plate of the device, it is automatically positioned at the proper height to allow for the thickness of the wallboard or ceiling paneling to be installed.

A second embodiment of the gauge has an elongate member with a pair of mutually opposed resilient gripping plates generally normal thereto. The gripping plates are spaced slightly closer to one another than the outside faces of adjacent conventionally spaced joists, e.g., 17.5 inches for standard 16-inch on center spacing. The central portion of the device is an elongate flat plate, which is offset from the lower plates of the grip members by an amount equal to the thickness of the ceiling paneling to be installed. The device is temporarily attached directly to the ceiling joists by gripping two adjacent joists between the gripping plates, with the electrical fixture being placed temporarily upon the central plate for proper positioning relative to the joists and uninstalled ceiling paneling.

These and other features of the present invention will become readily apparent upon further review of the following specification and drawings.

### BRIEF DESCRIPTION OF THE DRAWINGS

FIG. 1 is a detailed perspective view of a first embodiment of an installation gauge for electrical fixtures according to the present invention, illustrating various features thereof.

FIG. 2 is an environmental perspective view of the installation gauge of FIG. 1, showing its placement across the strapping members in a ceiling structure.

FIG. 3 is an environmental perspective view of the gauge of FIGS. 1 and 2, showing its use in positioning an electrical fixture for installation in the ceiling structure.

FIG. 4 is an environmental side elevation view of the gauge of FIGS. 1-3, showing its use in spacing an electrical fixture accurately relative to the finished ceiling structure.

FIG. 5 is a detailed perspective view of a second embodiment of an installation gauge for electrical fixtures according to the present invention.

FIG. 6 is an environmental side elevation view of the gauge of FIG. 5 in use, showing its use in spacing an electrical fixture accurately relative to the finished ceiling structure.

Similar reference characters denote corresponding features consistently throughout the attached drawings.

### DETAILED DESCRIPTION OF THE PREFERRED EMBODIMENTS

The present invention is an installation gauge for electrical fixtures, providing for the accurate spacing or positioning of the fixture relative to the thickness of the as yet uninstalled ceiling paneling (gypsum wallboard, etc.) during building construction. The gauge assures that electrical fixtures (ceiling light installations, ventilation fan boxes, etc.) are installed with their lower edges or lips substantially flush or coplanar with the inner or finish surface of the ceiling paneling in accordance with electrical code requirements.

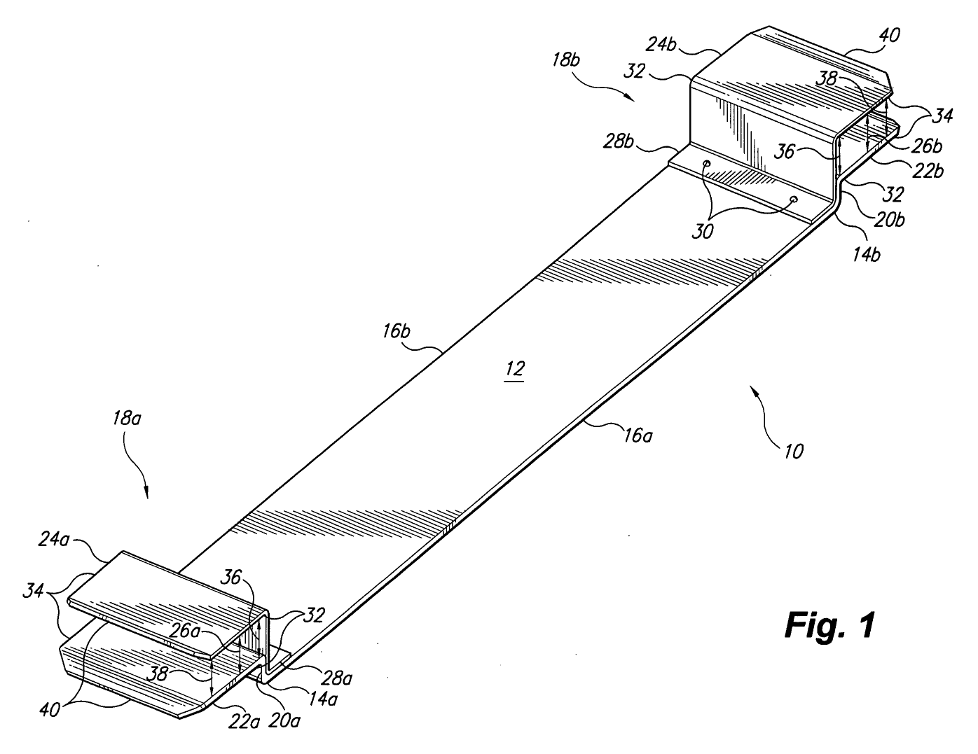

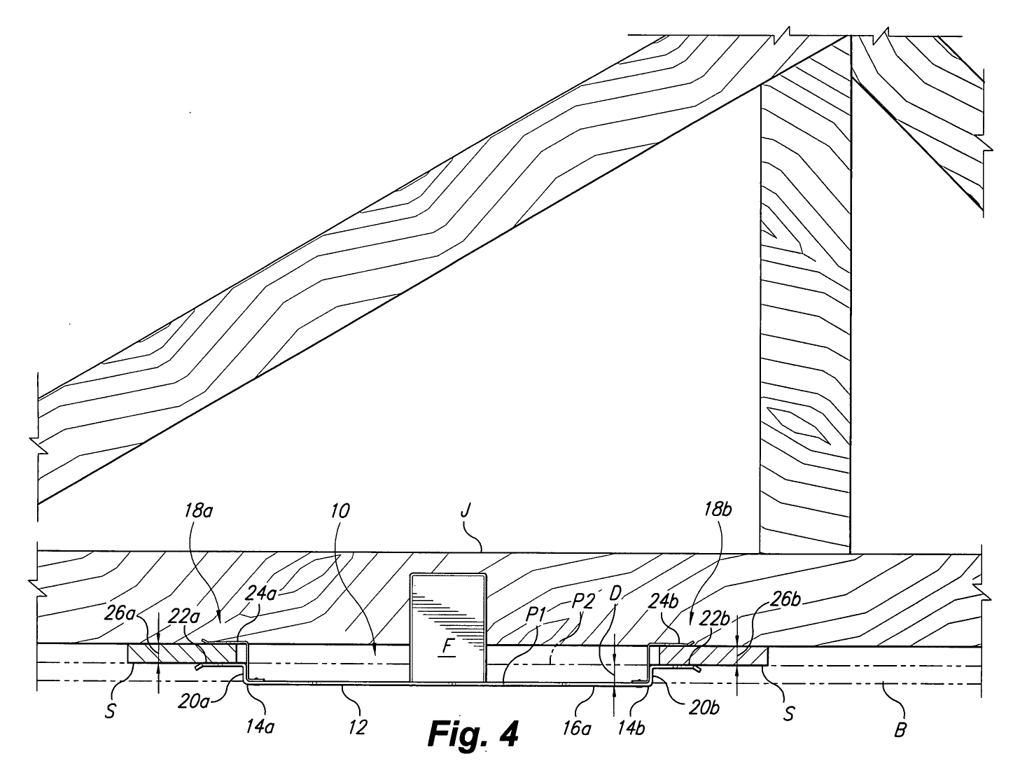

FIGS. 1 through 4 illustrate a first embodiment 10 of the installation gauge, which is configured for positioning an electrical fixture in a ceiling structure incorporating strapping members S or stringers installed between the ceiling joists J and ceiling paneling. The electrical fixture installation gauge 10 is longitudinally and laterally symmetrical, with the structure of each of the ends being mirror images to one another to allow the device to be placed temporarily without regard for longitudinal or lateral orientation. The gauge 10 comprises a thin, flat, elongate fixture support portion 12 having a first end 14a and an opposite second end 14b, with opposed, substantially parallel first and second edges 16a and 16b. The upper surface of the flat fixture support portion or plate 12 defines a fixture support plane P1 when the gauge 10 is temporarily positioned across the stringers S, as shown particularly in FIG. 4 of the drawings.

First and second grip members 18a and 18b extend from the first and second ends 14a, 14b, respectively, of the fixture support plate 12. Each member 18a, 18b includes a fixture offset member, respectively 20a and 20b, formed of a flat plate disposed substantially normal to the fixture support plate 12. A structure bottom contact plate, respectively 22a and 22b, extends from the respective offset member 20a, 20b, with the structure bottom contact plates 22a, 22b resting along and in contact with the bottom surface of respective strapping members S when the gauge 10 is positioned in the building structure. The two structure bottom contact plates 22a, 22b are substantially normal to their respective fixture offset members 20a, 20b, and are substantially coplanar with one another, and define a structure bottom plane P2 parallel to and offset from the structure support plane P1 by a fixture offset distance D equal to the vertical span of the fixture offset members 20a and 20b, as shown in FIG. 4 of the drawings.

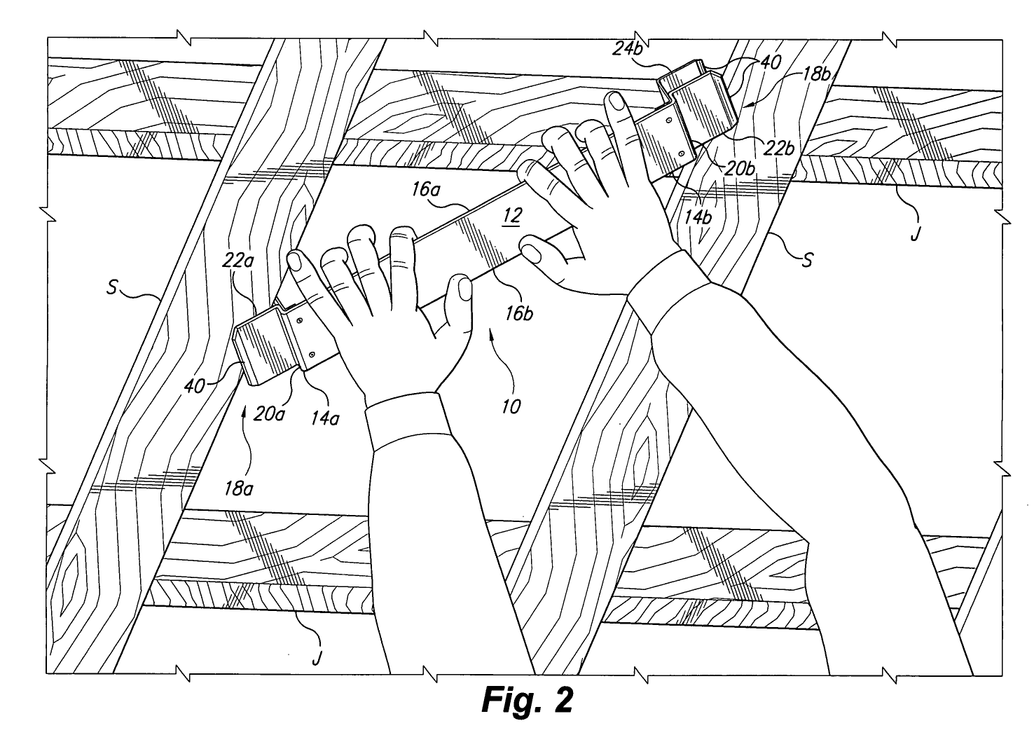

The electrical fixture installation gauge 10 of FIGS. 1 through 4 is configured to secure temporarily to adjacent spaced apart strapping members S, as shown in FIGS. 2 through 4. Accordingly, each of the grip members 18a, 18b at each end of the device further includes a structure top contact plate, respectively 24a and 24b, extending from the respective fixture offset member 20a, 20b. The structure top contact plates 24a, 24b, along with their respective bottom contact plates 22a and 22b, define opposite first and second grip spans 26a and 26b therebetween, with the structure grip spans 26a and 26b being dimensioned to fit closely about the thicknesses of the strapping members S to which the gauge 10 temporarily secures. The attachment ends 28a and 28b of the top contact plates 24a, 24b may be attached to the respective ends 14a, 14b of the fixture installation support plate 12 by any suitable means, e.g., rivets 30, as shown in the drawings. The structure contact plate assembly, and particularly the top contact plates 24a and 24b, are somewhat resilient and may be spread or flexed apart slightly over the strapping members S and released to grip the strapping members securely.

Each of the bottom contact plates 22a, 22b and top contact plates 24a, 24b has a throat end 32 and opposite distal end 34, shown most clearly in FIG. 1 of the drawings. The two plates of each grip member assembly 18a and 18b are generally parallel to one another, but converge slightly toward one another from their throat ends 32 toward their distal ends 34, with the distance or span 36 between their throat ends being slightly greater than the distance or span 38 between their distal ends. This provides a clamping action upon the strapping members S when the corresponding grip member assembly 18a, 18b is secured thereto in order to secure the installation gauge 10 positively in place. Each of the distal ends 34 of the bottom and top contact plates 22a, 22b, 24a, and 24b further includes a lip 40 extending therefrom, with the corresponding lips 40 of the bottom contact plate and its respective top contact plate diverging from one another toward their distal edges. This provides a wider distal lip edge for the two structure grip member assemblies 18a and 18b, thus facilitating the placement of the gauge 10 upon the two strapping members S as shown in FIG. 2.

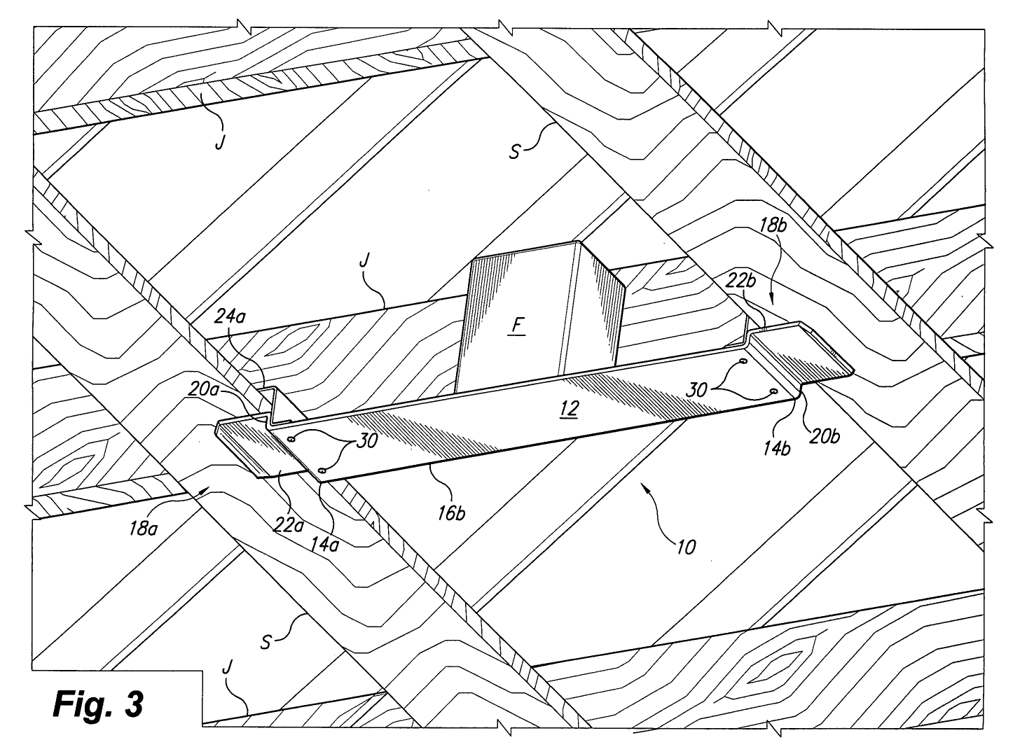

The electrical fixture installation gauge 10 greatly facilitates the precise placement and alignment of an electrical component box relative to other building structural members during electrical system installation. The gauge 10 is initially installed upon two adjacent strapping members S in the area where the electrical box installation is to be made, generally as indicated in FIG. 2 of the drawings. The span of the fixture installation support 12 is slightly less than the conventional spacing between adjacent or facing edges of the strapping members S, thus allowing the gauge 10 to be positioned at an angle between the straps S and rotated into position, generally as shown in FIG. 3 of the drawings. At this point, the electrical fixture F is placed atop the fixture installation support 12, as shown in FIGS. 3 and 4 of the drawings. The offset D provided between the bottom contact plates 22a and 22b and the fixture installation support 12 is predetermined to match the thickness of the ceiling panels or wallboard B to be installed across the strapping members S, thus placing the plane P1 of the installation support plate 12, and the bottom edge of the electrical fixture F resting thereon, substantially coplanar with the interior or finish surface of the ceiling wallboard panels B, as shown in FIG. 4. The electrical fixture F may then be permanently attached to some suitable structure, e.g., the joist J as shown in FIG. 4, with the lower edge of the fixture F lying in the same plane as the interior or finish surface of the ceiling wallboard B once it has been installed.

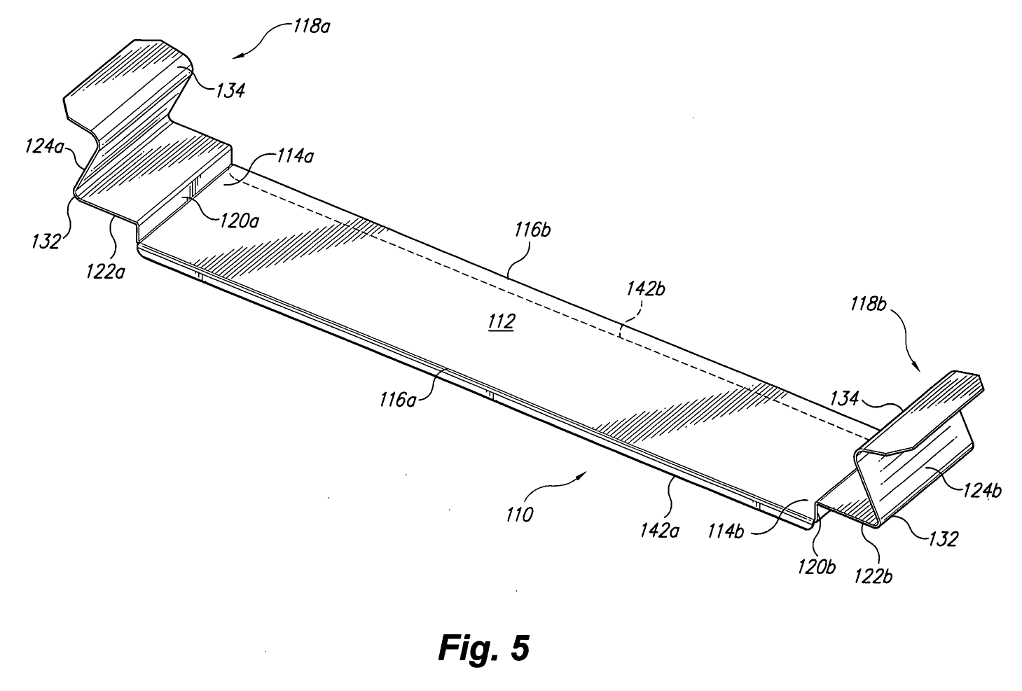

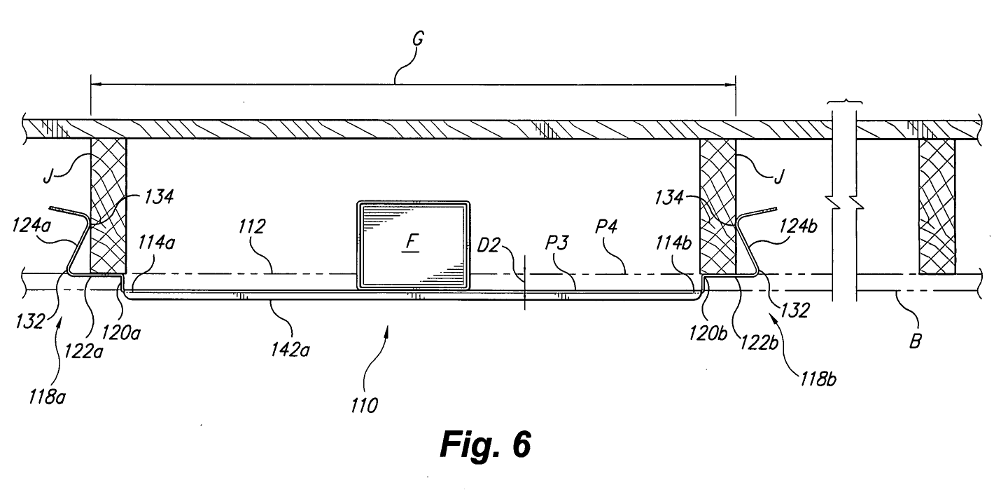

FIGS. 5 and 6 of the drawings illustrate a second embodiment of an installation gauge for electrical fixtures according to the present invention, designated as gauge 110, with the gauge 110 being configured for use directly across adjacent ceiling joists J where no intervening strapping members have been installed. The electrical fixture installation gauge 110 of FIGS. 5 and 6 is generally similar to the gauge 10 of FIGS. 1 through 4, comprising a thin, flat, elongate fixture support portion 112 having a first end 114a and an opposite second end 114b, with opposed, substantially parallel first and second edges 116a and 116b. The upper surface of the flat fixture support portion or plate 112 defines a fixture support plane P3 when the gauge 110 is temporarily positioned across the joists J, as shown particularly in FIG. 6 of the drawings.

First and second grip members 118a and 118b extend from the first and second ends 114a, 114b, respectively, of the fixture support plate 112. Each member 118a, 118b includes a fixture offset member, respectively 120a and 120b, formed of a flat plate disposed substantially normal to the fixture support plate 112. A bottom contact plate 122a and 122b extends from the offset members 120a, 120b, respectively, the bottom contact plates 122a, 122b resting along and in contact with the bottom surface of respective joists J when the gauge 110 is positioned in the building structure, generally as shown in FIG. 6. The two structure bottom contact plates 122a, 122b are substantially normal to their respective fixture offset members 120a, 120b and are substantially coplanar with one another, and define a structure bottom plane P4 parallel to and offset from the fixture support plane P3 by a fixture offset distance D2 equal to the vertical span of the fixture offset members 120a and 120b, as shown in FIG. 6 of the drawings.

The above-described structure for the installation gauge 110 of FIGS. 5 and 6 will be seen to be quite similar to the corresponding structure of the gauge 10 of FIGS. 1 through 4. However, the gauge 110 is configured to install removably directly upon the overlying ceiling joists J, rather than securing about the intervening strapping members, as in the embodiment of FIGS. 1 through 4. Accordingly, the installation gauge 110 of FIGS. 5 and 6 includes a resilient side grip member, respectively 124a and 124b, extending from the respective bottom contact plates 122a and 122b. These side grip members 124a, 124b are generally normal to their corresponding bottom contact plates (the angle is exaggerated in the drawings, for clarity), and define a structure grip span G equal to the distance between opposed faces of the joists J to which the gauge 110 removably secures, as shown in FIG. 6 of the drawings. Each of the side grip members 124a, 124b includes a base end 132 and an opposite distal end 134, with the distal ends 134 being at least slightly closer to one another than the base ends 132. In this manner, the more closely spaced distal ends 132 of the side grip members 124a and 124b resiliently grip the opposite faces of the adjacent joists J firmly therebetween to hold the gauge 110 temporarily, but securely, in place during the electrical fixture installation. The two side grip members 124a, 124b also preferably have mutually diverging distal lips 140, thereby facilitating the placement of the electrical fixture installation gauge 110 across the adjacent joists J.

The electrical fixture installation gauge 110 is preferably formed of a single, monolithic sheet of material, e.g., aluminum or other metal, or possibly a sufficiently durable plastic, etc. Aluminum is preferred for its light weight and the resilience of the material, depending upon the alloy and thickness used. Aluminum is also preferably used for the construction of the first embodiment installation gauge 10 of FIGS. 1 through 4, as well. However, the use of a single, constant width and thickness sheet of material for the second embodiment of the gauge 110 results in the gauge 110 having substantially uniform properties of flexure along its entire length, including the fixture installation support span 112, unless some means is provided to prevent such flexure. Accordingly, first and second stiffening flanges 142a and 142b are provided, depending from the respective first and second edges 116a and 116b of the fixture installation support or plate 112 and at least generally normal to the plane of the plate 112. These stiffening flanges 142a, 142b greatly increase the bending resistance of the installation support plate portion 112 of the installation gauge 110 while still allowing the two side grip members 124a and 124b to be flexed outwardly to grip the opposite faces or sides of adjacent joists J, generally as shown in FIG. 6.

The electrical fixture installation gauge 110 of FIGS. 5 and 6 is used by spreading the two side grip members 124a, 124b sufficiently to fit about the opposite or outwardly facing surfaces of the two adjacent joist members J, and positioning the device across the joists with the side grip members 124a, 124b gripping the joists J therebetween, generally as shown in FIG. 6. The electrical fixture or box F is placed atop the fixture installation support or plate 112, adjacent a joist or other support member to which the fixture F will be permanently attached. When the two bottom contact plates 122a, 122b of the gauge 110 are positioned in contact with the lower surfaces of the joists J, the offset of the bottom edge of the fixture box F will be equal to the thickness of the ceiling panel wallboard B to be installed, thus placing the lower edge of the electrical fixture F flush with the interior or finish surface of the ceiling panel B once it has been installed.

In conclusion, electrical fixture installation gauge greatly facilitates the precise installation of an electrical fixture or box in the ceiling structure of a building under construction before the installation of the ceiling paneling. The two embodiments of the installation gauge are adapted for use in ceiling structures incorporating additional strapping installed beneath the ceiling joists, and in structures where no such strapping is installed, respectively. In both cases, the installation gauge for electrical fixtures assures that the electrical fixture will be installed precisely relative to its depth and the thickness of the yet to be installed ceiling panel material, with the lower or bottom lip of the box lying flush with the interior finished surface of the ceiling panel once it has been installed. Accordingly, the gauge prove to be a most popular accessory for electricians and others who have need to precisely place electrical components in building structures during new construction, remodeling, and other building projects.

It is to be understood that the present invention is not limited to the embodiments described above, but encompasses any and all embodiments within the scope of the following claims.

I claim:

1. An installation gauge for electrical fixtures, comprising:
a thin, flat, elongate fixture support having a first end, a second end opposite the first end, a first edge, and a second edge opposite the first edge, the fixture support defining a fixture support plane;
resilient first and second grip members extending from the first end and the second ends, respectively, of the fixture support, the first and second grip members each having a bottom contact plate substantially coplanar with one another, the first and second bottom contact plates defining a structure bottom plane; and
first and second fixture offset members disposed between the first and second bottom contact plates and the fixture support, the first and second fixture offset members defining a fixture offset distance between the fixture support plane and the structure bottom plane.

2. The installation gauge for electrical fixtures according to claim 1, wherein each of said grip members further comprises a top contact plate extending from said fixture offset members, each of the top contact plates being spaced apart from the corresponding bottom contact plate of said grip member, each of the top contact plates and the corresponding bottom contact plates defining a structure grip span therebetween.

3. The installation gauge for electrical fixtures according to claim 2, wherein each structure top contact plate further includes an attachment end riveted to the respective end of the fixture support.

4. The installation gauge for electrical fixtures according to claim 2, wherein:
each said bottom contact plate has a throat end and a distal end opposite the throat end; and
each said top contact plate has a throat end and a distal end opposite the throat end; the distal ends of said bottom contact plates and corresponding said top contact plates being spaced more closely to one another than the throat ends of said bottom contact plates and said top contact plates.

5. The installation gauge for electrical fixtures according to claim 2, wherein:
the distal end of each said bottom contact plate defines a lip; and
the distal end of each said top contact plate defines a lip, the lips of corresponding said bottom contact plates and said top contact plates diverging mutually from one another.

6. The installation gauge for electrical fixtures according to claim 1, wherein each said grip member further comprises a side grip member extending resiliently from each said bottom contact plate generally normal thereto, the side grip members defining a structure grip span therebetween.

7. The installation gauge for electrical fixtures according to claim 6, further including a stiffening flange depending from each edge of the fixture support generally normal thereto.

8. The installation gauge for electrical fixtures according to claim 6, wherein each said side grip member further includes a base end and a distal end opposite the base end, the distal ends of said side grip members being spaced more closely to one another than the base ends thereof.

9. The installation gauge for electrical fixtures according to claim 6, wherein the distal end of each said side grip member further includes a lip, the lips of said side grip members diverging mutually from one another.

10. The installation gauge for electrical fixtures according to claim 1, wherein the fixture support and said first and second structure grip members are formed of aluminum.

11. An installation gauge for electrical fixtures, comprising:
a thin, flat, elongate fixture support having a first end and a second end opposite the first end, the fixture support defining a fixture support plane;
resilient first and second structure grip members extending from the first end and the second ends of the fixture support, each of the grip members having;
a fixture offset member extending from each of the ends of the fixture support substantially normal thereto;
a bottom contact plate extending from each of the fixture offset members substantially coplanar with one another and defining a structure bottom plane, the fixture offset members defining a fixture offset distance between the fixture support plane and the structure bottom plane; and
a top contact plate extending from each of the fixture offset members, the top contact plates being spaced apart from the corresponding bottom contact plates, each said top contact plates and corresponding bottom contact plates defining a structure grip span therebetween.

12. The installation gauge for electrical fixtures according to claim 11, wherein each said top contact plate has an attachment end riveted to the respective end of the fixture support.

13. The installation gauge for electrical fixtures according to claim 11, wherein:
each said bottom contact plate has a throat end and a distal end opposite the throat end; and
each said top contact plate has a throat end and a distal end opposite the throat end, the distal ends of said bottom contact plates corresponding said top contact plates being spaced more closely to one another than the throat ends of said bottom contact plates and said top contact plates.

14. The installation gauge for electrical fixtures according to claim 11, wherein the distal ends of said bottom contact plates and said top contact plates each have a lip, the lips said bottom contact plates and corresponding said top contact plates diverging mutually from one another.

15. The installation gauge for electrical fixtures according to claim 11, wherein the fixture support and first and second grip members are formed of aluminum.

16. An installation gauge for electrical fixtures, comprising:
a thin, flat, elongate fixture support having a first end, a second end opposite the first end, a first edge, and a second edge opposite the first edge, the fixture support defining a fixture support plane;
resilient first and second grip members extending from the first and second ends, respectively, of the fixture support, each of the grip members comprising;
a fixture offset member extending from each of the ends of the fixture support substantially normal thereto;
a bottom contact plate extending from each of the fixture offset members substantially coplanar with one another and defining a structure bottom plane, the fixture offset members defining a fixture offset distance between the fixture support plane and the structure bottom plane; and
a side grip member extending resiliently from each of the bottom contact plates generally normal thereto, the side grip members defining a structure grip span therebetween.

17. The installation gauge for electrical fixtures according to claim 16, further including a stiffening flange depending from each of the edges of the fixture support generally normal thereto.

18. The installation gauge for electrical fixtures according to claim 16, wherein each said side grip member has a base end and a distal end opposite the base end, the distal ends being spaced more closely to one another than the base ends.

19. The installation gauge for electrical fixtures according to claim 16, wherein the distal ends of said side grip members has a lip, the lips of said side grip members diverging mutually from one another.

20. The installation gauge for electrical fixtures according to claim 16, wherein the fixture support and said first and second structure grip members are formed of aluminum.
